(19) United States
(12) Patent Application Publication
(10) Pub. No.: US 2007/0064546 A1
(43) Pub. Date: Mar. 22, 2007

(54) Optical disc system and method for controlling the same

(75) Inventor: Jeong Il Choi, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/488,730

(22) Filed: Jul. 19, 2006

(30) Foreign Application Priority Data
Sep. 21, 2005 (KR) 2005-87889

(51) Int. Cl. G11B 17/22

(52) U.S. Cl. 369/30.3

(57) ABSTRACT

An optical disc system including a plurality of decks and a method for controlling the optical disc system are provided for managing pieces of title information recorded on discs respectively loaded in the decks in an integrated manner. The control method includes reading pieces of title information of optical discs each loaded in one of the decks, storing the read title information pieces together with deck positions respectively associated with the title information pieces, and displaying the stored title information pieces and the associated deck positions in an integrated manner in a single title table.

### CROSS-REFERENCE TO RELATED APPLICATIONS

This application claims all benefits accruing under 35 U.S.C. §119 from Korean Patent Application No. 2005-87889, filed on Sep. 21, 2005, in the Korean Intellectual Property Office, the disclosure of which is incorporated by reference herein.

### BACKGROUND OF THE INVENTION

1. Field of the Invention

The present invention relates to an optical disc system and a method for controlling the same, and more particularly, to an optical disc system including a plurality of decks and a method for controlling the optical disc system, which are capable of managing different pieces of title information recorded on different optical discs loaded respectively in the decks in an integrated manner.

2. Related Art

Recently, an optical disc system has been provided with double deck capabilities, including a pair of decks each performing a playback or recording operation for an optical disc. Such an optical disc system can perform a playback or recording operation in accordance with a user's request when optical discs are loaded in the decks respectively. Typically, such an optical disc system is configured such that one deck can perform both the playback and recording operations, while another deck can perform only the playback operation.

In such an optical disc system, a content recorded on an optical disc is registered as a title. In order to more easily manage such a title, the optical disc system provides a visual display of a title management screen, such as a title list screen for a user to ascertain the content of information recorded on each optical disc respectively. Using the title management screen, the optical disc system can more easily perform management operations associated with playback and editing for plural titles recorded in the optical disc loaded in each deck.

However, there are problems in typical optical disc systems which perform title management functions. For example, typical optical disc systems provide a title management function in which a title management screen, as shown in FIG. 1, or alternatively, as shown in FIG. 2, is displayed in association with only the titles of the optical disc loaded in the deck selected by the user. In this case, playback/editing functions can be performed only for the titles of the optical disc loaded in the deck selected by the user. As a result, if a title management function associated with playback or editing for the titles of an optical disc loaded in another deck is desired, playback/editing functions can only be realized only after the user selects another deck. Thus, the title playback/editing functions can be performed only for the selected optical disc.

For example, when a user desires a title of an optical disc loaded in a second deck when the title management screen associated with a first deck is displayed, the optical disc system exits from the title management screen of the first deck, selects the second deck for a visual display of the title management screen of the second deck for the user's selection, and selects a desired title from the displayed title management screen to perform a playback or editing operation for the selected title. Similarly, when the user selects a desired title of an optical disc loaded in the first deck when the title management screen associated with the second deck is displayed, the optical disc system exits from the title management screen of the second deck, selects the first deck for a visual display of the title management screen of the first deck, and selects a desired title from the displayed title management screen to perform a playback or editing operation for the selected title.

Thus, all typical optical disc systems do not provide simultaneously visual display of pieces of information from both the optical discs loaded in the two decks respectively. This is because the typical optical disc systems are only configured to display information of only the optical disc loaded in the deck selected by the user at a time. As a result, there are problems of limited usability and inconvenience in association with the title management function.

Accordingly, there is a need for an optical disc system having a plurality of decks in which title information from different optical discs loaded respectively in different decks can be displayed and managed in an integrated manner.

### SUMMARY OF THE INVENTION

Various aspects and example embodiments of the present invention to provide an optical disc system including a plurality of decks and a method for controlling the same, which are capable of managing pieces of title information recorded on different optical discs respectively loaded in the decks for a visual display in an integrated manner.

Additional aspects and/or advantages of the invention will be set forth in part in the description which follows and, in part, will be obvious from the description, or may be learned by practice of the invention.

In accordance with an aspect of the present invention, there is provided a method for controlling an optical disc system including a plurality of decks, comprising: reading pieces of title information of optical discs each loaded in one of the decks; storing the read title information pieces together with deck positions respectively associated with the title information pieces; and displaying the stored title information pieces and the associated deck positions in an integrated manner in a single title table.

information may include names of titles and play times of the titles. The plurality of decks may comprise at least one recording/playback deck which is an optical disc recorder to perform both a recording operation and a playback operation for an optical disc, and at least one playback deck which is an optical disc player to perform only a playback operation for an optical disc.

The method may further comprise determining the decks in which the optical discs have been loaded, respectively, to execute the reading of title information pieces only for the decks in which the optical discs have been loaded. The displaying of the stored title information pieces may be executed in such a manner that the title information pieces of the optical discs loaded in active ones of the decks are displayed preferentially to the title information pieces of the optical discs loaded in inactive ones of the decks.

In accordance with another aspect of the present invention, there is provided a method for controlling an optical disc system including a first deck which can perform both a recording operation and a playback operation for an optical disc, and a second deck which can perform only a playback operation for an optical disc, comprising: reading title information of an optical disc loaded in one or more decks; storing the read title information together with deck position information associated with the title information; and displaying the stored title information and the associated deck position information in response to a title information display command for an active one of the deck input by a user.

When the stored title information comprises a single title information piece, the title information piece may be displayed alone, together with the deck position associated with the title information piece. When the stored title information comprises a plurality of title information pieces, the title information pieces may be displayed in an integrated manner, together with deck positions respectively associated with the title information pieces.

The displaying of the stored title information may be executed in such a manner that the title information of the optical disc loaded in an active one of the first and second decks is displayed preferentially to the title information of the optical disc loaded in an inactive one of the first and second decks.

In accordance with another aspect, the present invention provides an optical disc system comprising a first deck which can perform both a recording operation and a playback operation for an optical disc, and a second deck which can perform only a playback operation for an optical disc, further comprising: a first signal processor which reads first title information of an optical disc loaded in the first deck; a second signal processor which reads second title information of an optical disc loaded in the second deck; an input unit which receives a command input by a user in association with display of title information; a display unit which displays a content associated with display of title information; and a controller which stores the first and second title information read by the first and second signal processors when the associated optical discs are loaded in the first and second decks, respectively, in a memory included in the controller, and displays, via the display unit, the stored first and second title information in an integrated manner in response to the command input, via the input unit, together with deck positions respectively associated with the first and second title information.

When the stored title information comprises a single title information piece, the title information piece may be displayed alone, together with the deck position associated with the title information piece. When the stored title information comprises a plurality of title information pieces obtained from optical discs loaded in different decks, the title information pieces may be displayed in an integrated manner, together with deck positions respectively associated with the title information pieces.

The controller may display the title information of the optical disc loaded in an active one of the first and second decks preferentially to the title information of the optical disc loaded in an inactive one of the first and second decks.

In addition to the example embodiments and aspects as described above, further aspects and embodiments of the present invention will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a schematic view illustrating a title management screen of an optical disc loaded into one deck of a typical optical disc system, for example, a first deck;

FIG. 2 is a schematic view illustrating a title management screen of an optical disc loaded into another deck of the typical optical disc system, for example, a second deck;

FIG. 3 is a perspective view illustrating an example optical disc system according to an embodiment of the present invention;

FIG. 4 is a block diagram illustrating a control configuration of an optical disc system according to the embodiment of the present invention;

FIG. 5 is a schematic view illustrating a title management screen to simultaneously display title information of optical discs loaded into different decks, for example, first and second decks of an optical disc system according to an embodiment of the present invention; and

FIGS. 6 and 7 are flow charts illustrating a method for controlling an optical disc system in accordance with an embodiment of the present invention.

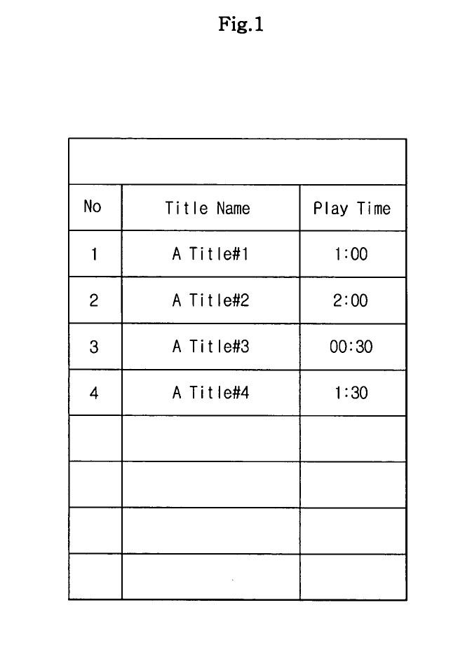

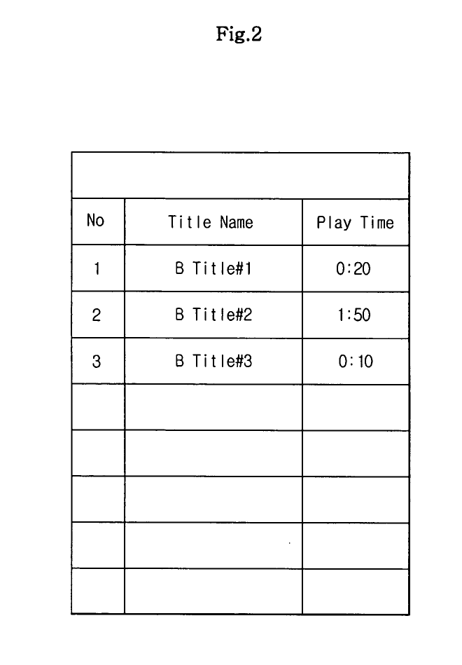

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

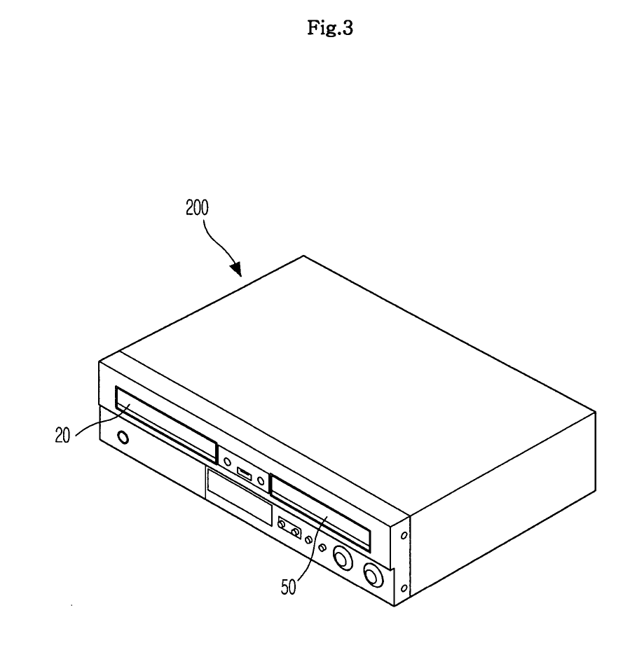

Referring to FIG. 3, an optical disc system 200 according to an embodiment of the present invention is illustrated. The optical disc system 200 includes a plurality of decks, for example, two decks as shown, to enable a multi-task operation in association with copying, recording, and playback. Specifically, the optical disc system 200 includes a first deck 20 and a second deck 50, and can perform a multi-task operation, for example, data copying under the condition in which the first deck 20 is used as a source, and the second deck 50 is used as a target, playback of video or music through the first deck 20, or recording of broadcast signals, received via a television (TV), through the second deck 50 during the playback operation of the first deck 20.

As shown, for example, in FIG. 3, the first deck 20 can be an optical disc recorder, namely, a recording/playback deck, which can perform both the recording and playback operations for an optical disc. In contrast, the second deck 50 can be an optical disc player, namely, a playback deck, which can perform only the playback operation for an optical disc.

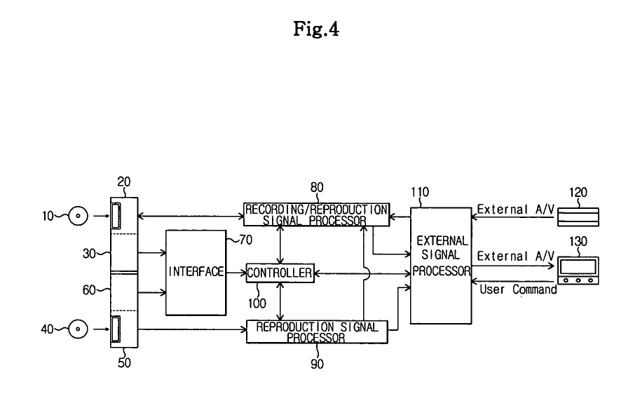

FIG. 4 illustrates a block diagram of an optical disc system 200 according to an embodiment of the present invention. As shown in FIG. 4, the optical disc system 200 includes the first deck 20 which performs recording and playback operations for an optical disc 10 loaded in the first deck 20, and the second deck 50 which performs a playback operation for an optical disc 40 loaded in the second deck 50.

The optical discs which are applicable to the present invention may include Digital Versatile Disc-Read Only Memory (DVD-ROM), DVD-Recordable (DVD-R), DVD-Rewritable (DVD-RW), and DVD-Random Access Memory (DVD-RAM). In addition, the optical discs may have various formats, such as, for example, V-mode and VR-mode.

Each of the first and second decks 20 and 50 includes an optical pickup and an optical pickup driver (not shown), for emission of a laser beam for recording/reproducing data on/from a respective optical disc loaded therein.

The optical disc system 200 also includes first and second key input units 30 and 60 which are provided at the first and second decks 20 and 50, respectively, to input user commands associated with processing operations for respective optical discs 10 and 40. The first and second key input units 30 and 60 may be integrated into a single key input unit.

User commands input through the first and second key input units 30 and 60 are sent to a controller 100, via an interface 70. In response to the user commands, the controller 100 controls the associated constituent elements of the optical disc system 200.

The optical disc system 200 further includes a recording/reproduction signal processor 80 which reads title information recorded on the optical disc 10 loaded in the first deck 20 under the control of the controller 100, and sends the read title information to the controller 100. The controller 100 stores the title information in a memory equipped in the controller 100, together with an associated deck position. In this case, the controller 100 assigns serial addresses to pieces of the read title information, and stores the title information pieces at the serial addresses in the memory, respectively. For example, when the optical disc 10 loaded in the first deck 20 is played back, the recording/reproduction signal processor 80 encodes recorded data read from the optical disc 10, and sends the encoded signal to an external signal processor 110 which is also included in the optical disc system 200. The external signal processor 110 performs a signal processing operation for the encoded signal, in order to output corresponding video and audio signals. The video and audio signals are then transmitted to a television (TV) 130 serving as a display unit. The external signal processor 110 also functions to perform a signal processing operation for external audio and video signals (external A/V signal) received from a tuner 120, which may be part of the television (TV) 130, and sends the processed external A/NV signal to the recording/reproduction signal processor 80. In this case, the recording/reproduction signal processor 80 decodes the AN signal, and records the decoded signal on the optical disc 10 of the first deck 20.

The optical disc system 200 further includes a reproduction signal processor 90 which reads title information recorded on the optical disc 40 loaded in the second deck 50 under the control of the controller 100, and sends the read title information to the controller 100. The controller 100 stores the title information in the memory of the controller 100, together with an associated deck position. In this case, the controller 100 assigns serial addresses to pieces of the read title information, and stores the title information pieces at the serial addresses in the memory, respectively. For example, when the optical disc 40 loaded in the second deck 50 is played back, the reproduction signal processor 90 encodes recorded data read from the optical disc 10. When it is desired to externally output the encoded signal for playback thereof, the reproduction signal processor 90 sends the encoded signal to the TV 130 via the external signal processor 110. Also, the recorded data read from the optical disc 40 may be sent to the recording/reproduction signal processor 80 via the reproduction signal processor 90 so that the recorded data is copied to the optical disc 10 loaded in the first deck 20. Of course, in this case, the optical disc 10 must be a recordable optical disc.

The user may input user commands such as a menu display command and a title information display command to the controller 100, via the external signal processor 110, by selecting an input key provided at the TV 130 or a menu key or an ANY key provided at a remote controller for the TV 130. The menu and title information may be displayed in the form of guidance texts. In response to the user commands, the controller 100 controls the associated constituent elements of the optical disc system 200.

In particular, the controller 100 displays, on the TV 130, a menu list according to an ANY key function executed in response to a user command generated in accordance with selection of the ANY key provided at the remote controller, in order to assist selection of a menu by the user.

Each of the key input units 30 and 60 is provided with a play change key to select a deck to be activated. The controller 100 determines whether the currently-active deck is the first deck 20 or the second deck 50, based on the input of the play change key.

Also, the controller 100 determines, through the recording/reproduction signal processor 80, whether or not the optical disc 10 has been loaded in the first deck 20, and determines, through the reproduction signal processor 90, whether or not the optical disc 40 has been loaded in the second deck 50.

Hereinafter, operation of the controller 100 will be described. The controller 100 first determines whether or not the optical disc 10 has been loaded in the first deck 20 and whether or not the optical disc 40 has been loaded in the second deck 50. The controller 100 then reads title information of the loaded optical disc or loaded optical discs. After the reading of the title information, the controller 100 assigns serial addresses to pieces of the read title information, and stores the title information pieces at the serial addresses in the memory, respectively. The reading of the title information is executed for each deck, irrespective of whether or not the deck is in an active state. When a menu display command is input by the user after completion of the storage of the title information and deck position for each deck, the controller 100 determines whether the active deck is the first deck 20 or the second deck 50. Based on the results of the determination, the controller 100 displays a menu list associated with the active deck on the TV 120. Also, in response to a title information display command input by the user, the controller 100 scans the memory thereof to display the title information stored in the memory. Where both the title information of the first optical disc 10, namely, the first title information, and the title information of the second optical disc 40, namely, the second title information, are stored in the memory, the controller 100 displays both the first title information and the second title information in an integrated manner in a single title table, together with respective deck positions associated with the first title information and the second title information. In this case, the title information of the optical disc loaded in the active deck is displayed preferentially to that of the optical disc loaded in the inactive deck, namely, in a higher order than that of the optical disc loaded in the inactive deck. Meanwhile, where the first title information or the second title information is stored alone, the controller 100 displays the stored first or second title information and the associated deck position.

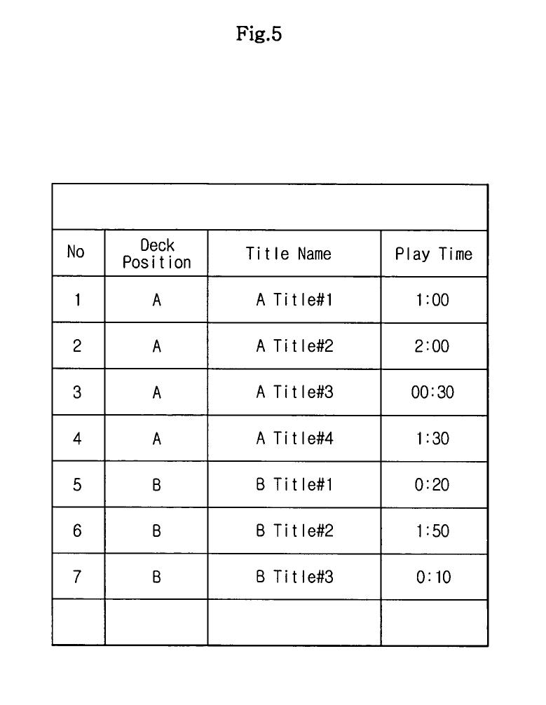

The above operation will be described with reference to an example shown in FIG. 5 in which it is assumed, for the sake of simplicity, that the first deck 20 is represented by a deck A, the second deck 50 is represented by a deck B, the first title information consists of four titles, for example, ATitle#1, ATitle#2, ATitle#3, and ATitle#4 each having a certain play time, and the second title information consists of four titles, for example, BTitle#1, BTitle#2, BTitle#3, and BTitle#4, each having a certain play time. For example, a play time for ATitle#1 at deck A is 1hour; a play time for ATitle#2 at deck A is 2hours; a play time for ATitle#3 at deck A is 30 minutes; and a play time for ATitle#4 at deck A is 1:30 hours. Likewise, a play time BTitle#1 at deck B is 20 minutes; a play time for BTitle#2 at deck B is 1:50 hours; and a play time for BTitle#3 at deck B is 10 minutes.

In this case, even when only the deck A is in an active state, and a menu list is displayed in association with the deck A in response to a menu display command, the controller 100 displays not only the title information of the optical disc loaded in the deck A, namely, the first title information, but also the title information of the optical disc loaded in the deck B namely, the second title information. Thus, the controller 100 displays even that title information of the optical disc loaded in the inactive deck. That is, the controller 100 displays not only the title information of the optical disc loaded in one deck, but also the title information of the optical disc loaded in the other deck, irrespective of selection of the active deck.

Accordingly, it is possible to provide convenience in operating and using the optical disc system 200 because the optical disc system 200 can display the title information of optical discs loaded in both the decks irrespective of selection of one deck by the user, contrary to the conventional cases in which only the title information of the optical disc loaded in the selected deck is displayed.

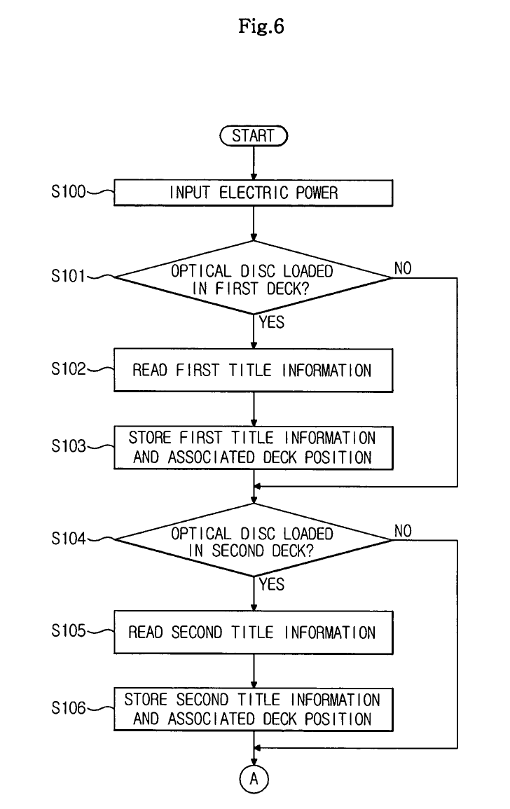

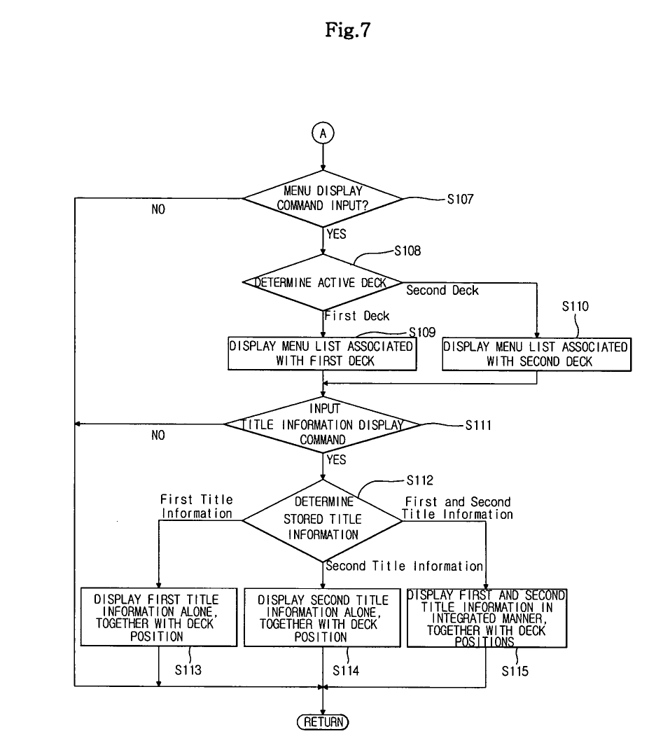

The operation of the controller will be described in more detail with reference to FIGS. 6 and 7 herein below.

When electric power is applied to the optical disc system 200 at block S100, the controller 100 first determines whether or not an optical disc 10 has been loaded in the first deck 20 at block S101. If the optical disc 10 has not been loaded in the first deck 20, the controller 100 proceeds to determine whether or not an optical disc 40 has been loaded in the second deck 50 at block S104. On the other hand, if the optical disc 10 has been loaded in the first deck 20, the controller 100 reads the first title information from table of contents (TOC) information recorded on the optical disc 10 at block S102. The controller 100 then stores the read first title information in the memory of the controller 100 at block S103, together with the deck position (first deck) corresponding to the first title information. In this case, the controller 100 assigns serial addresses to respective pieces of the first title information after the reading of the first title information, to store the pieces of the first title information in the memory at the corresponding addresses, respectively.

Next, the controller 100 determines whether or not the optical disc 40 has been loaded in the second deck 50 at block S104. If the optical disc 40 has not been loaded in the second deck 50, the controller 100 proceeds to determine whether or not a menu display command has been input from a user at block S107, as shown in FIG. 7. On the other hand, if the optical disc 40 has been loaded in the second deck 50, the controller 100 reads the second title information from TOC information recorded on the optical disc 40 at block S105. The controller 100 then stores the read second title information in the memory of the controller 100 at block S106, together with the deck position (second deck) corresponding to the second title information. In this case, the controller 100 assigns serial addresses to respective pieces of the second title information after the reading of the second title information, to store the pieces of the second title information in the memory at the corresponding addresses, respectively.

Under the above condition, the controller 100 determines whether or not a menu display command has been input from the user at block S107, shown in FIG. 7. If no menu display command has been input, the controller 100 proceeds to “RETURN”, as shown in FIG. 7, to execute a predetermined routine. On the other hand, if the menu display command has been input, the controller 100 determines which deck is in an active state at block S108. In this case, the controller 100 determines whether the currently active deck is the first deck 20 or the second deck 50, based on the input of the play change key provided at either the key input unit 30 or the key input unit 60. When the active deck is the first deck 20, the controller 100 displays a list of menus, which are executable in the first deck 20 and includes a title information display menu, via a display unit 130, as shown in FIG. 4, at block S109. On the other hand, when the active deck is the second deck 20, the controller 100 displays a list of menus, which are executable in the second deck 50 and includes a title information display menu, via the display unit 130, shown in FIG. 4, at block S110.

Thereafter, the controller 100 determines whether or not a title information display command has been input from the user after the display of the menu list at block S111. When no title information display command has been input, the controller 100 proceeds to “RETURN”, as shown in FIG. 7, to execute the predetermined routine. On the other hand, when a title information display command has been input, the controller 100 determines whether only the first or second title information or both the first and second title information have been stored at block S112. When only the first title information has been stored, the controller 100 displays only the first title information and the associated deck position (first deck), via a display unit 130, as shown in FIG. 4, at block S113. When only the second title information has been stored, the controller 100 displays only the second title information and the associated deck position (second deck), via the display unit 130, as shown in FIG. 4, at block S114. On the other hand, when both the first title information and the second title information have been stored, the controller 100 displays the first title information and the second title information in an integrated manner, via the display unit 130, as shown in FIG. 4, at block S115, together with the association deck positions (first and second decks).

As apparent from the above description, the present invention provides an optical disc system including a plurality of decks and a method for controlling the same, which are capable of reading and storing pieces of title information recorded on optical discs respectively loaded in the decks, and displaying the stored title information pieces in an integrated manner in a single title table, and thus, managing the title information pieces associated with respective decks in an integrated manner. As a result, the convenience in using the optical disc system is enhanced.

While the present invention has been particularly shown and described with reference to exemplary embodiments thereof, it will be understood by those of ordinary skill in the art that various changes in form and details may be made therein without departing from the spirit and scope of the present invention. For example, components of an optical disc system, as shown in FIG. 3 and FIG. 4, can be arranged differently as long as multiple decks are utilized and different title information from different optical discs can be obtained and simultaneously displayed on a display unit where a user can make selection. In addition, one or more decks can be utilized, and not limited to two decks, as shown in FIG. 3 and FIG. 4. Accordingly, it is intended, therefore, that the present invention not be limited to the various example embodiments disclosed, but that the present invention includes all embodiments falling within the scope of the appended claims.

What is claimed is:

1. A method for controlling an optical disc system including a plurality of decks, comprising:
reading pieces of title information of optical discs each loaded in one of the decks;
storing read title information pieces together with deck positions respectively associated with the title information pieces; and
displaying stored title information pieces and the associated deck positions in an integrated manner in a single title table.

2. The method according to claim 1, wherein the title information includes names of titles and play times of the titles.

3. The method according to claim 1, wherein the plurality of decks comprise at least one recording/playback deck which is an optical disc recorder to perform both a recording operation and a playback operation for an optical disc, and at least one playback deck which is an optical disc player to perform only a playback operation for an optical disc.

4. The method according to claim 1, further comprising:
determining the decks in which the optical discs have been loaded, respectively, to execute the reading of title information pieces only for the decks in which the optical discs have been loaded.

5. The method according to claim 1, wherein the displaying of the stored title information pieces is executed in such a manner that the title information pieces of the optical disc loaded in an active one of the decks are displayed preferentially to the title information pieces of the optical discs loaded in inactive ones of the decks.

6. A method for controlling an optical disc system including a first deck to perform both a recording operation and a playback operation for an optical disc, and a second deck to perform only a playback operation for an optical disc, comprising:
reading title information of an optical disc loaded in one or more decks;
storing the read title information together with deck position information associated with the title information; and
displaying the stored title information and the associated deck position information in response to a title information display command for an active one of the decks input by a user.

7. The method according to claim 6, wherein:
when the stored title information comprises a single title information piece obtained from the optical disc loaded into one of the first and second decks, the title information piece is displayed alone, together with the deck position associated with the title information piece; and
when the stored title information comprises a plurality of title information pieces obtained from the optical disc loaded into both the first and second decks, the title information pieces are displayed in an integrated manner, together with deck positions respectively associated with the title information pieces.

8. The method according to claim 6, wherein the displaying of the stored title information is executed in such a manner that the title information of the optical disc loaded in an active one of the first and second decks is displayed preferentially to the title information of the optical disc loaded in an inactive one of the first and second decks.

9. An optical disc system comprising a first deck to perform both a recording operation and a playback operation for an optical disc, and a second deck to perform only a playback operation for an optical disc, further comprising:
a first signal processor which reads first title information of an optical disc loaded in the first deck;
a second signal processor which reads second title information of an optical disc loaded in the second deck;
an input unit which receives a command input by a user in association with display of title information;
a display unit which displays a content associated with display of title information; and
a controller which stores the first and second title information read by the first and second signal processors when the associated optical discs are loaded in the first and second decks, respectively, in a memory, and controls a visual display of stored title information in an integrated manner, via the display unit, in response to the command input, together with deck positions respectively associated with the first and second title information.

10. The optical disc system according to claim 9, wherein:
when the stored title information comprises a single title information piece obtained from the optical disc loaded into one of the first and second decks, the title information piece is displayed alone, together with the deck position associated with the title information piece; and
when the stored title information comprises a plurality of title information pieces obtained from the optical discs loaded into both the first and second decks, the title information pieces are displayed in an integrated manner, together with deck positions respectively associated with the title information pieces.

11. The optical disc system according to claim 9, wherein the controller displays, via the display unit, the title information of the optical disc loaded in an active one of the first and second decks preferentially to the title information of the optical disc loaded in an inactive one of the first and second decks.

12. The optical disc system according to claim 9, wherein the title information includes names of titles and play times of the titles.

13. The optical disc system according to claim 9, wherein the controller is configured to:
determine whether only one of the first and second title information, or both the first and second title information have been stored in the memory;
when only the first title information has been stored in the memory, provide a visual display of only the first title information together with the associated deck position, via the display unit;
when only the second title information has been stored in the memory, provide a visual display of only the second title information together with the associated deck position; or
when both the first and second title information have been stored in the memory, provide a visual display of both the first and second title information together with associated deck positions in an integrated manner.

14. The method according to claim 6, wherein the title information includes names of titles and play times of the titles.

15. The method according to claim 9, wherein:
when the title information of an optical disc obtained from the first deck has been stored in a memory, displaying only the title information together with a deck position associated with the first deck, via a display unit;
when the title information of an optical disc obtained from the second deck has been stored in the memory, displaying only the title information together with the deck position associated with the second deck; or
when the title information of optical discs obtained from the first and second decks have been stored in the memory, displaying the title information together with deck positions associated with the first and second decks.

16. An optical disc system comprising:
a plurality of decks to receive corresponding optical discs loaded therein;
a signal processor unit arranged to read title information from one or more optical discs loaded in one or more decks;
a display unit arranged to provide a visual display of a content associated with title information; and
a controller configured to control operations of the decks, the signal processor unit and the display unit, including storing the title information obtained from one or more optical discs loaded in one or more decks in a memory, and providing a visual display of stored title information together with one or more deck positions in an integrated manner, via the display unit, in response to a command input.

17. The optical disc system according to claim 16, wherein:
when the stored title information comprises a single title information piece obtained from an optical disc loaded into one of the decks, the title information piece is displayed alone, together with the deck position associated with the title information piece; and
when the stored title information comprises a plurality of title information pieces obtained from optical discs loaded into multiple decks, the title information pieces are displayed in an integrated manner, together with deck positions respectively associated with the title information pieces.

18. The optical disc system according to claim 16, wherein the controller displays, via the display unit, the title information of the optical disc loaded in an active one of the multiple decks preferentially to the title information of the optical disc loaded in an inactive one of the multiple decks.

19. The optical disc system according to claim 16, wherein the title information includes names of titles and play times of the titles.

20. The optical disc system according to claim 16, wherein the controller is configured to:
determine whether title information obtained from a single deck has been stored in the memory, or whether title information obtained from multiple decks have been stored in the memory;
when the title information of only a single deck has been stored in the memory, provide a visual display of the title information obtained from a single deck together with the associated deck position, via the display unit; and
when the title information of multiple decks have been stored in the memory, provide a visual display of the title information obtained from multiple decks together with associated deck positions in an integrated manner.
